(19) United States
(12) Patent Application Publication
(10) Pub. No.: US 2005/0008151 A1
(43) Pub. Date: Jan. 13, 2005

(54) Processor device and method for data protection by means of data block scrambling

(75) Inventor: Bor-Sung Liang, Kaohsiung City (TW)

Correspondence Address: BACON & THOMAS, PLLC, 625 SLATERS LANE, FOURTH FLOOR, ALEXANDRIA, VA, 22314, US

(73) Assignee: Samplus Technology Co., Ltd., Hsinchu (TW)

(21) Appl. No.: 10/878,323

(22) Filed: Jun. 29, 2004

(30) Foreign Application Priority Data
Jul. 9, 2003 (TW) 092118767

(51) Int. Cl. H04N 7/167

(52) U.S. Cl. 380/37

(57) ABSTRACT

A processor device and method for data protection by means of data block scrambling is disclosed, which has a processor core, a cache and a block scrambling/de-scrambling device. The processor core executes instructions of the processor and access data in a memory. The cache is connected to the processor core in order to provide it with a memory space for quickly accessing data. The block scrambling/de-scrambling device is coupled between the cache and the memory in order to scramble data block outputted by the cache based on a seed generated by a seed generator or to de-scramble data block inputted by the memory based on the seed.

### BACKGROUND OF THE INVENTION

1. Field of the Invention

The present invention relates to the technical field of processor and, more particularly, to a processor device and method for data protection by means of data block scrambling.

2. Description of Related Art

To protect data storage medium against any unauthorized access, data scrambling technology is frequently employed to encode data for encryption. However, among typical processors, data scrambling operation can cause conflict between the complexity of encoder circuitry and the performance. Complicated encoding/decoding approach needs much extra time and it causes low performance. To increase the performance, simple encoding/decoding approach is used but its encrypted data can be cracked easily.

Generally, typical scrambling operation is performed based on single data entry. If scrambling/de-scrambling operation performed at the single data entry access takes time dt, total time for n data accesses is n*dt, which pulls the entire system performance down. In addition, such a typical scrambling has definite data change types. To increase data randomness and thus enhance data protection, it needs complicated scrambling operation and takes much extra time in scrambling/de-scrambling operation. Further, typical scrambling operation is performed based on a data entry, which cannot use the feature of processor structure so that the time spending on scrambling/de-scrambling operation cannot be reduced.

Therefore, it is desirable to provide an improved processor device and method to mitigate and/or obviate the aforementioned problems.

### SUMMARY OF THE INVENTION

The object of the present invention is to provide a processor and method for data protection by means of data block scrambling, which can avoid cracking encrypted data easily and reduce time spending on scrambling/de-scrambling operation to thus enhance the performance of system access.

In accordance with one aspect of the present invention, there is provided a processor device for data protection by means of data block scrambling. A data block consists of plural data entries. The processor includes a processor core, a fast memory and a block scrambling/de-scrambling device. The processor core executes instructions of the processor and access data in a memory device. The fast memory is coupled to the processor core and stores at least one data block from the memory device to thus provide the processor core with a memory space for quickly accessing data. The block scrambling/de-scrambling device is coupled between the fast memory and the memory device in order to scramble data block outputted by the fast memory based on a seed generated by a seed generator or to de-scramble data block inputted by the memory device based on the seed.

In accordance with another aspect of the present invention, there is provided a method for data protection by means of data block scrambling in a processor. A data block consists of plural data entries. The processor has a fast memory to store at least one data block from an external memory device, thereby providing the processor with a memory space for quickly accessing data. The method includes the steps: (A) generating at least one seed by a seed generator; (B) when the data block is written from the fast memory to the memory device, applying data block scrambling to the data block based on the seed; and (C) when the data block is written from the memory device to the fast memory, applying data block de-scrambling to the data block based on the seed.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a processor for data protection by means of data block scrambling in accordance with the invention;

FIG. 2 is a schematic flow of scrambling a data block in accordance with the invention;

FIG. 3 is a schematic flow of further scrambling a data block in accordance with the invention;

FIG. 4 is a schematic flow of reversely scrambling the data block of FIG. 3 in accordance with the invention;

FIG. 5 is a schematic flow of performing 2 D block and address scrambling for the data block of FIG. 3 in accordance with the invention;

FIG. 6 is a schematic flow of address lines for scrambling address bus in accordance with the invention; and

FIG. 7 is a block diagram of another embodiment in accordance with the invention.

### DETAILED DESCRIPTION OF THE PREFERRED EMBODIMENT

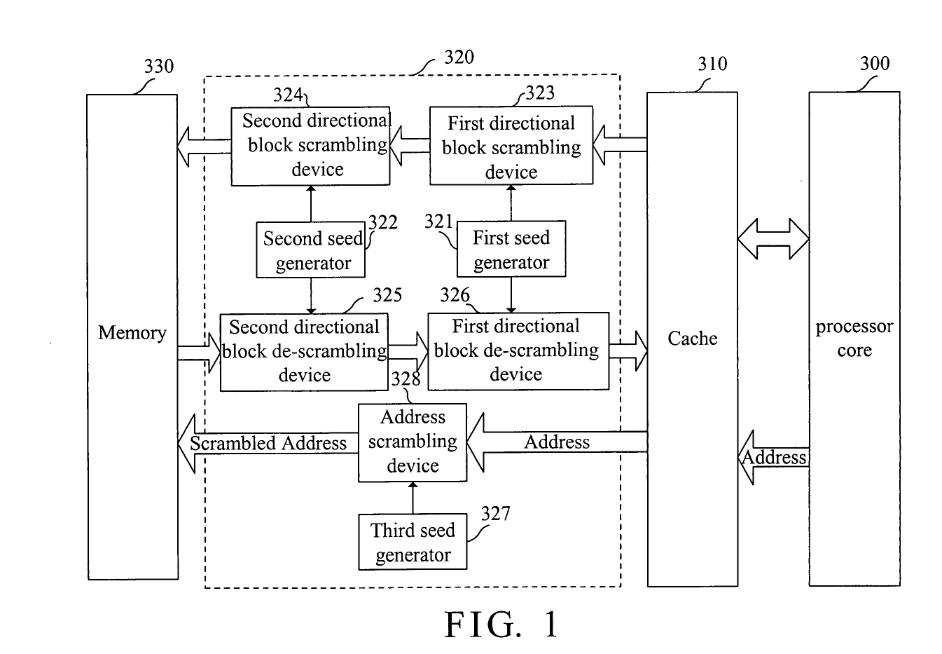

FIG. 1 is a block diagram of a processor for data protection by means of data block scrambling. As shown, the processor includes a processor core 300, a fast memory 310 and a block scrambling/de-scrambling device 320. The processor core 300 executes instructions of the processor and access data in a memory 330. The fast memory 310 is connected to the processor core 300 and stores at least one data block from the memory 330 to thus provide the processor core 330 with a memory space for quickly accessing data. Preferably, the fast memory 310 is a cache and the size of a data block is a cache line. The block scrambling/de-scrambling device 320 is coupled between the fast memory 310 and the memory 330 in order to scramble data block output by the fast memory 310 based on a seed generated by a seed generator or to de-scramble data block input by the memory 330 based on the seed.

The block scrambling/de-scrambling device 320 includes a first seed generator 321, a second seed generator 322, a first directional block scrambling device323, a second directional block scrambling device 324, a second directional block de-scrambling device 325, a first directional block de-scrambling device 326, a third seed generator 327 and an address scrambling device 328.

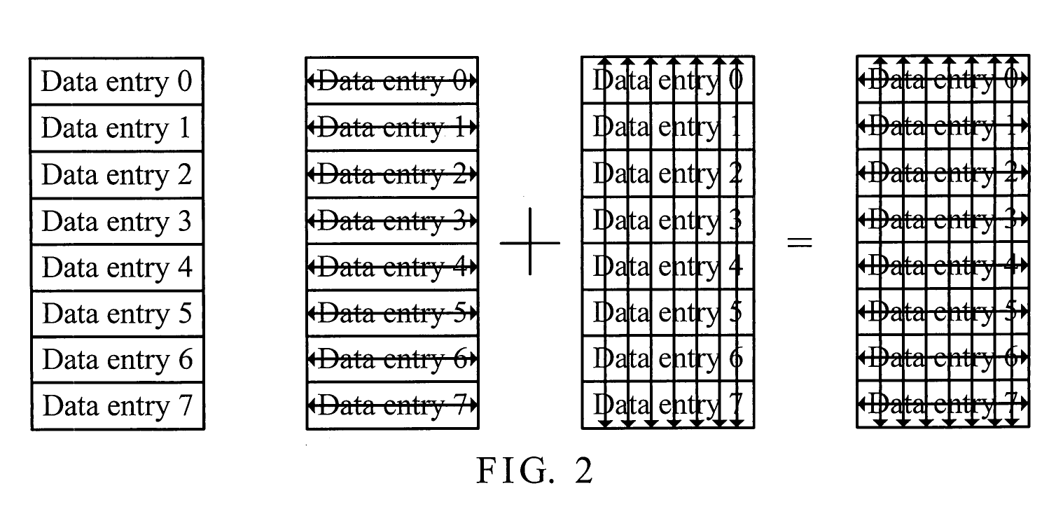

The processor core 300 performs memory access in a unit of a word length (32 bits). To increase access efficiency, the fast memory 310 performs data block access in a unit of a cache line. When the fast memory 310 is to write a cache line to the memory 330, as shown in FIG. 2, the block scrambling and de-scrambling device 320 applies horizontal and then vertical scrambling or vertical and then horizontal scrambling to the cache line.

When the device 320 applies horizontal scrambling to the cache line, the first seed generator 321 generates a first seed in accordance with an address output by the fast memory 310 or a preset function. The first directional block scrambling device 323 is connected to an output of the fast memory 310 in order to apply horizontal (first directional) data block scrambling to the output of the fast memory 310 based on the first seed. The second seed generator 322 generates a second seed in accordance with an address output by the fast memory 310 or a preset function. The second directional block scrambling device 324 is connected to the output of the fast memory 310 in order to apply vertical (second directional) data block scrambling to the output of the fast memory 310 based on the second seed.

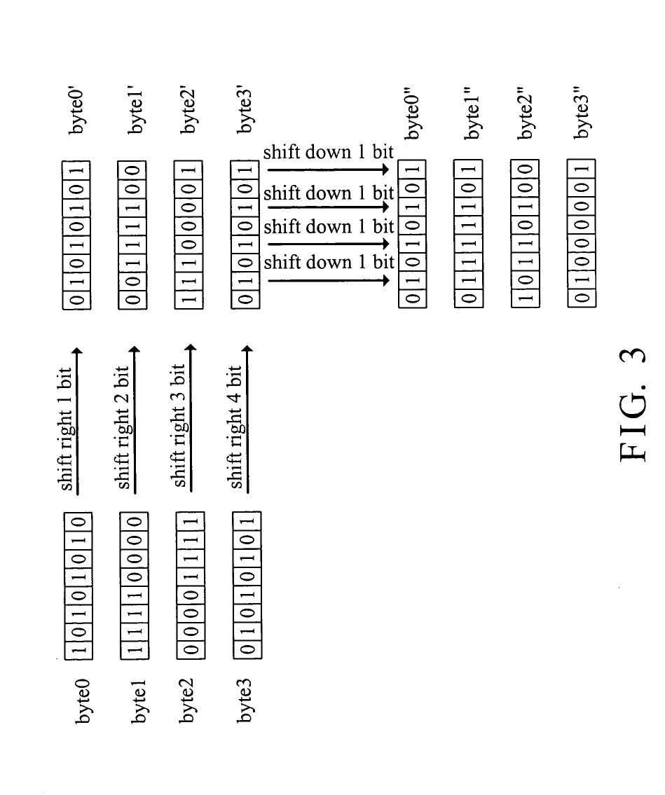

FIG. 3 is a schematic flow of further scrambling a data block when a cache line data block is written in the memory 330. As shown, the cache line data block consists of four 8-bit bytes. The first directional block scrambling device 323 shifts a first byte (byte0) right 1 bit in a cyclic form, i.e., the rightmost is shifted to the leftmost bit. Similarly, the first directional block scrambling device 323 shifts a second byte (byte 1) right 2 bits , a third byte (byte2) right 3 bits and a fourth byte (byte3) right 4 bits. After the aforementioned shifting is complete, byte0′, byte1′, byte2′ and byte3′ are generated respectively.

Next, the second directional block scrambling device 324 applies vertical (second directional) data block scrambling to byte0′, byte1′, byte2′ and byte3′, i.e., shift down 1 bit to byte0′, byte1′, byte2′ and byte3′ at bit0, bit2, bit4 and bit6 respectively. Thus, bit0 of byte0′ is shifted to bit0 of byte 1′, bit0 of byte1′ is shifted to bit0 of byte2′, bit0 of byte2′ is shifted to bit0 of byte3′, and bit0 of byte3′ is shifted to bit0 of byte0′. After the horizontal and vertical scrambling, data block becomes considerable randomness, thereby achieving the purpose of data protection.

When the fast memory 310 is to read a cache line from the memory 330, the second seed generator 322 generates a second seed in accordance with an address output by the fast memory 310 or a preset function. The second directional block de-scrambling device 325 is connected to the memory 330 in order to apply vertical data block de-scrambling to the output of the memory 330 based on the second seed. The first seed generator 321 generates a first seed in accordance with the address output by the fast memory 310 or a preset function. The first directional block de-scrambling device 326 is connected to the output of the second directional block de-scrambling device 325 in order to apply horizontal data block de-scrambling to the output of the second directional block de-scrambling device 325 based on the first seed and then generate de-scrambling output to the fast memory 310.

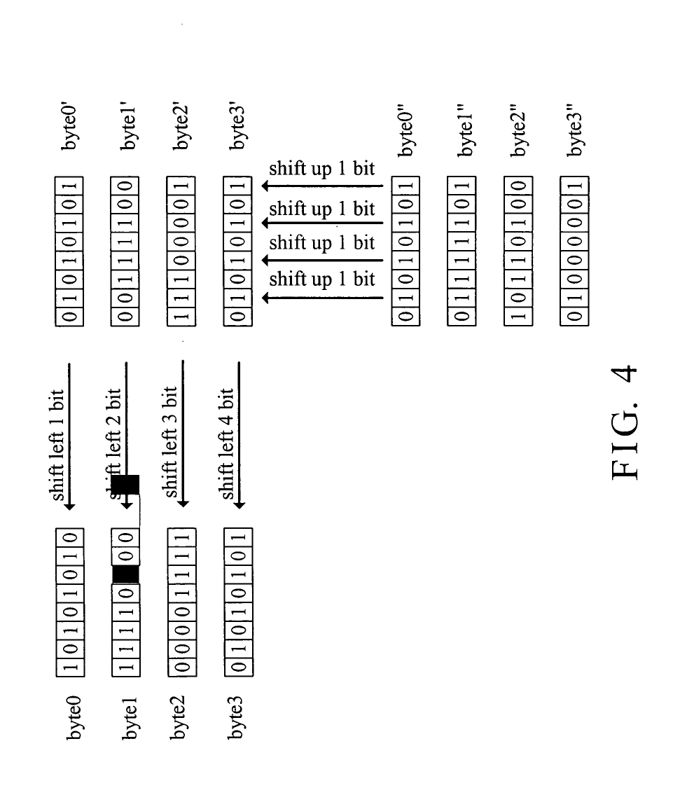

FIG. 4 is a schematic flow of de-scrambling a cache line data block as it is read to the fast memory 310. As shown, the cache line data block consists of four 8-bit bytes (byte0″, byte 1″, byte2″ and byte3″). The second directional block de-scrambling device 325 applies vertical data block de-scrambling to byte0″, byte1″, byte2″ and byte3″, i.e., shift up 1 bit to byte0″, byte1″, byte2″ and byte3″ at bit0, bit2, bit4 and bit6 respectively. Thus, bit0 of byte1″ is shifted to bit0 of byte0″, bit0 of byte2″ is shifted to bit0 of byte1″, bit0 of byte3″ is shifted to bit0 of byte2″, and bit0 of byte0″ is shifted to bit0 of byte3″. Accordingly, byte0′, byte1′, byte2′ and byte3′ are generated.

The first directional block de-scrambling device 326 shifts the first byte (byte0′) left 1 bit in a cyclic form, i.e., the leftmost is shifted to the rightmost bit. Next, the first directional block de-scrambling device 326 shifts the second byte (byte1′) left 2 bits , the leftmost 2 bits are shifted to the rightmost 2 bits . Similarly, the first directional block de-scrambling device 326 shifts the third byte (byte2′) right 3 bits and a fourth byte (byte3′) right 4 bits. After the aforementioned shifting is complete, byte0, byte1, byte2 and byte3 are generated respectively.

As shown in FIG. 4, because a data block with considerable randomness is stored in the memory 330, it can avoid the content to be easily analyzed and known. In addition, the data block with considerable randomness can be scrambled by the block scrambling and de-scrambling device 320 in reverse to obtain an original data for use by the processor core 300.

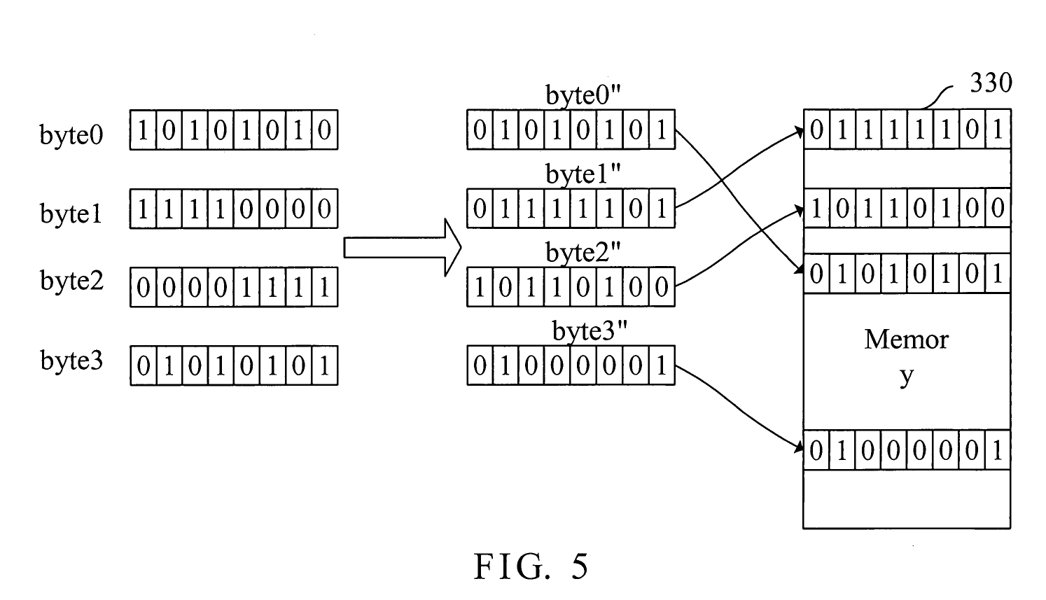

The third seed generator 327 generates a third seed. The address scrambling device 328 is connected to address bus of the fast memory 310 in order to apply address scrambling to address lines from the fast memory 310 based on the third seed. FIG. 5 is a schematic flow of performing address scrambling after the aforementioned 2 D block scrambling for the data block of FIG. 3 and then storing it in the memory 330. As shown in FIG. 3, after 2 D block scrambling is applied to an ordered data, stored addresses for scrambled data are scrambled to further protect the memory content.

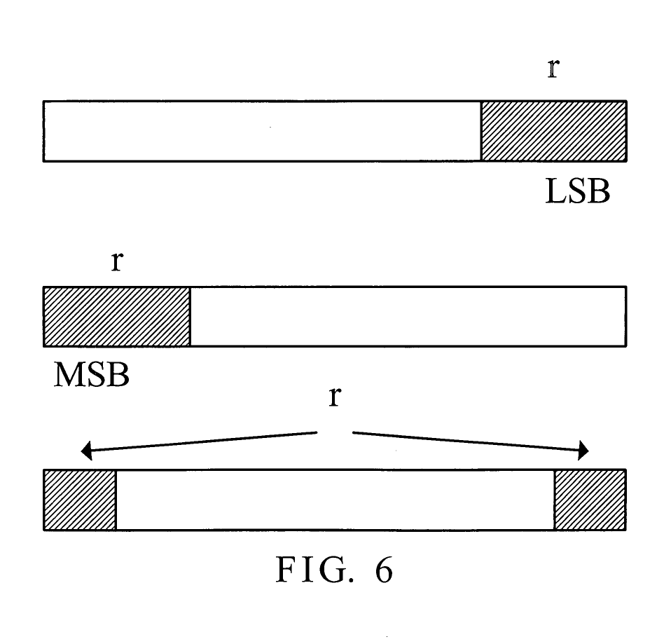

The address scrambling device 328 generates a scrambled address in accordance with r address lines on the address bus. As shown in FIG. 6, the address bus can have partial address lines without scrambled. When r address lines to be scrambled is of LSB, it can successively store data in data block at a same cache line. When r address lines to be scrambled is of MSB, it can keep page address of a cache line unchanged. Since physical memory capacity is much less than addresses used by the processor core 300, address line number q on the address bus is greater than or equal to scrambled address line number p.

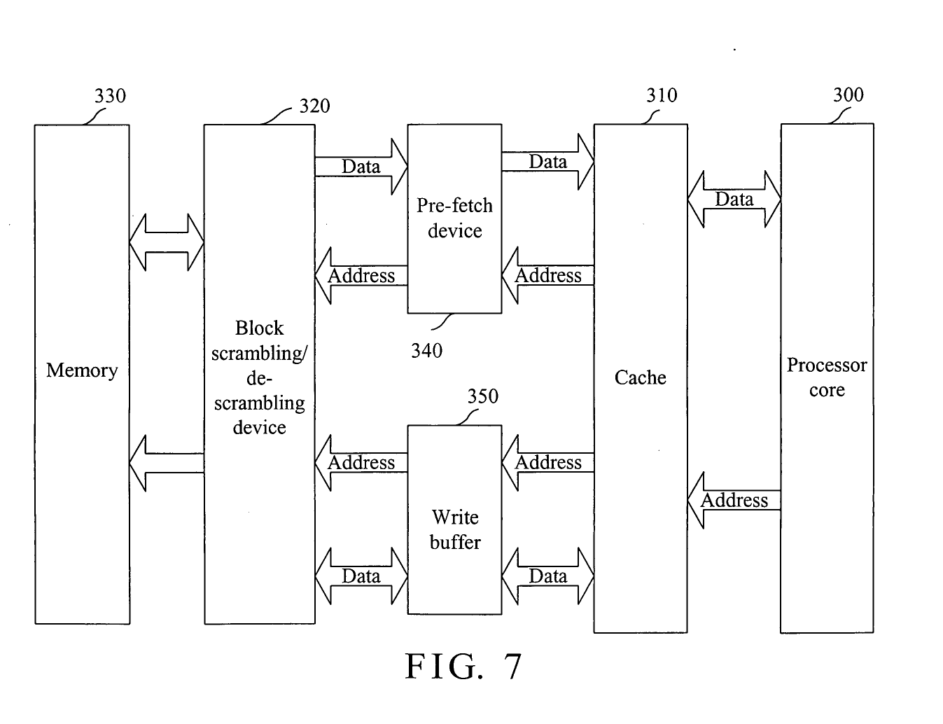

FIG. 7 is a block diagram of another embodiment in accordance with the invention. As shown, this embodiment further includes a pre-fetch device 340 and a write buffer 350. The pre-fetch device 340 is coupled between the fast memory 310 and the first directional block de-scrambling device 323 in order to perform a pre-fetching function for the fast memory 310. The write buffer 350 is coupled between the fast memory 310 and the first directional block de-scrambling device 323 and first directional block de-scrambling device326 in order to perform a write buffer function for the fast memory 310.

In view of foregoing, it is known that the invention can apply block scrambling to ordered cache line data block and thus form scrambled data block with considerable randomness for storing in the memory. Accordingly, the data block with considerable randomness can avoid the content to be cracked and known easily by others, thereby achieving the purpose of data protection. In addition, the data block with considerable randomness can be scrambled by the block scrambling and de-scrambling device 320 in reverse, thus the fast memory can obtain an original data for use by the processor core 300. The invention further uses the pre-fetch device 340 and the write buffer 350, which can increase the access speed of the fast memory regardless of operation speed of the block scrambling and de-scrambling device 320.

Although the present invention has been explained in relation to its preferred embodiment, it is to be understood that many other possible modifications and variations can be made without departing from the spirit and scope of the invention as hereinafter claimed.

1. A processor for data protection by means of data block scrambling, a data block consisting of plural data entries, the processor comprising:
a processor core, which executes instructions of the processor and accesses data in a memory device;
a fast memory, which is coupled to the processor core and stores at least one data block from the memory to thus provide the processor core with a memory space for quickly accessing data; and
a block scrambling/de-scrambling device, which is coupled between the fast memory and the memory device in order to scramble data block outputted by the fast memory based on a seed generated by a seed generator or to de-scramble data block inputted by the memory device based on the seed.

2. The processor as claimed in claim 1, wherein the fast memory is a cache.

3. The processor as claimed in claim 1, wherein the data block is a cache line having data to be accessed.

4. The processor as claimed in claim 1, wherein the block scrambling/de-scrambling device comprises:
a first seed;
a second seed;
a first directional block scrambling device connected to an output of the fast memory, to apply first directional data block scrambling to the output of the fast memory based on the first seed;
a second directional block scrambling device connected to an output of the first directional block scrambling device, to apply second directional data block scrambling to the output of the first directional block scrambling device based on the second seed;
a second directional block de-scrambling device connected to the memory device, to apply second directional data block de-scrambling to an output of the memory based on the second seed; and
a first directional block de-scrambling processor connected to an output of the second directional block de-scrambling device, to apply first directional data block de-scrambling to the output of the second directional block de-scrambling device based on the first seed and accordingly output an original data to the fast memory.

5. The processor as claimed in claim 4, wherein the first seed is the same as the second seed.

6. The processor as claimed in claim 4, wherein the first directional data block is vertical to the second directional data block.

7. The processor as claimed in claim 4, wherein the block scrambling/de-scrambling device comprises:
a third seed; and
an address scrambling device connected to address bus of the fast memory, to apply address scrambling to addresses sent by the fast memory based on the third seed.

8. The processor as claimed in claim 4, further comprising a pre-fetch device coupled between the fast memory and the first directional block de-scrambling device, to perform a pre-fetching function for the fast memory.

9. The processor as claimed in claim 4, further comprising a write buffer coupled between the fast memory and the first directional block scrambling device, to perform a write buffering function for the fast memory

10. The processor as claimed in claim 7, wherein address line number q on the address bus is equal to address line number p scrambled.

11. The processor as claimed in claim 7, wherein address line number q on the address bus is not equal to scrambled address line number p.

12. A method for data protection by means of data block scrambling in a processor, a data block consisting of plural data entries, the processor having a fast memory to store at least one data block from an external memory device, thereby providing the processor with a memory space for quickly accessing data, the method comprising the steps of:
(A) determining a scrambling type;
(B) applying data block scrambling to the data block in accordance with the scrambling type when a data block is written from the fast memory to the memory device; and
(C) applying data block de-scrambling to the data block in accordance with the scrambling type when the data block is written from the memory device to the fast memory.

13. The method as claimed in claim 12, wherein the step (A) generates at least one seed to determine the scrambling type.

14. The method as claimed in claim 12, wherein the step (A) generates a first seed and a second seed, to determine the scrambling type.

15. The method as claimed in claim 14, wherein the step (B) comprises the steps of:
(B1) applying first directional data block scrambling to the data block based on the first seed and thus generating a scrambled data block; and
(B2) applying second directional data block scrambling to the scrambled data block based on the second seed.

16. The method as claimed in claim 14, wherein the step (C) comprises the steps of:
(C1) applying second directional data block de-scrambling to the data block based on the second seed and thus generating a de-scrambled data block; and
(C2) applying first directional data block de-scrambling to the de-scrambled data block based on the first seed.

17. The method as claimed in claim 15, wherein the first directional data block is vertical to the second directional data block.

18. The method as claimed in claim 12, further comprising the steps of:
(D) generating a third seed; and
(E) applying address scrambling to addresses sent by the fast memory based on the third seed.

19. The method as claimed in claim 18, wherein a width of address signal not scrambled is equal to a width of address signal scrambled.

20. The method as claimed in claim 18, wherein a width of address signal not scrambled is not equal to a width of address signal scrambled.
